(19) United States
(12) Patent Application Publication
(10) Pub. No.: US 2010/0327070 A1
(43) Pub. Date: Dec. 30, 2010

(54) TOUCH SENSITIVE INTERFACE FOR HEATING OR AIR CONDITIONING A VEHICLE, AND METHOD FOR ADJUSTING SAME

(75) Inventor: Christian Bouchard, Rueil Malmaison (FR)

Correspondence Address: YOUNG & THOMPSON, 209 Madison Street, Suite 500, Alexandria, VA, 22314, US

(73) Assignee: CONTINENTAL AUTOMOTIVE FRANCE, Toulouse (FR)

(21) Appl. No.: 12/867,760

(22) PCT Filed: Mar. 27, 2009
(86) PCT No.: PCT/EP09/02260

§ 371 Date: Aug. 16, 2010

(30) Foreign Application Priority Data
May 26, 2008 (FR) 0802831

(51) Int. Cl. F24F 5/00; G08B 6/00; B60Q 3/00

(52) U.S. Cl. 236/49.3; 340/407.2; 340/449

(57) ABSTRACT

A touch-sensitive interface (7) for a heating and/or air-conditioning device (9) of a motor vehicle (5) includes at least one heat-sensitive wall (11a, 11b) accessible to the fingers (13a, 13b) of a user and designed to be heated and/or cooled by a heating and/or cooling element (15) arranged behind this wall (11a, 11b) so that, upon contact with the wall, the user has a feeling of hot or cold.

The invention relates to a touch-sensitive interface for a motor vehicle heating and/or air-conditioning device.

Traditionally, the cabin temperature is adjusted by action on a rotary knob or by incremental/decremental step changes to a temperature value using push buttons.

The value of this temperature or the direction in which the controls are operated are checked via a screen or a graphic illustrating the hot or cold zone, and this checking is therefore (essentially) visual.

One of the objectives of the invention in this field is to allow the user to adopt a more intuitive approach when he or she wishes to adjust the heating and/or air-conditioning of the vehicle cabin.

Another objective is for this user to be able to perform this adjustment practically “blind”.

Another objective is for this adjustment to occupy the least possible amount of the user's concentration.

Another objective is to avoid recourse to traditional controls using buttons or keys.

In order to address all or some of these objectives, the proposal here is for the interface to comprise at least one heat-sensitive wall accessible to the fingers of a user and designed to be heated and/or cooled by heating and/or cooling means arranged behind this wall so that, upon contact with said wall, the user has a feeling of hot or cold.

One advantage is that the user then does not have to look at the traditional temperature display screen or at any graphic index customarily displayed on part of the instrument panel, in order to determine whether this temperature is going up or down; he can feel it through his fingers.

In addition to this interface, the invention here also covers an air-conditioning device for the cabin of a motor vehicle, comprising:
the aforementioned touch-sensitive interface, and
adjustable means for the air-conditioning of the cabin by delivering air at a more or less higher temperature or at a more or less cooler temperature to this cabin, said air-conditioning means being coupled to the touch-sensitive interface for controlling the temperature of the air delivered as a function of the setting defined by the action of the fingers of the user on the interface.

A motor vehicle comprising a cabin equipped with this interface is also covered.

As too is a method for acting on adjustable means for heating or means for air-conditioning the cabin of a motor vehicle, this method being such that:
at least one heat-sensitive wall accessible to the fingers of a user and defining a touch-sensitive interface between this user and said heating or air-conditioning means is heated and/or cooled, and
air that is more or less hot or more or less cold is delivered into the cabin via said heating or air-conditioning means according to the action of the finger or fingers of the user on the heat-sensitive wall(s).

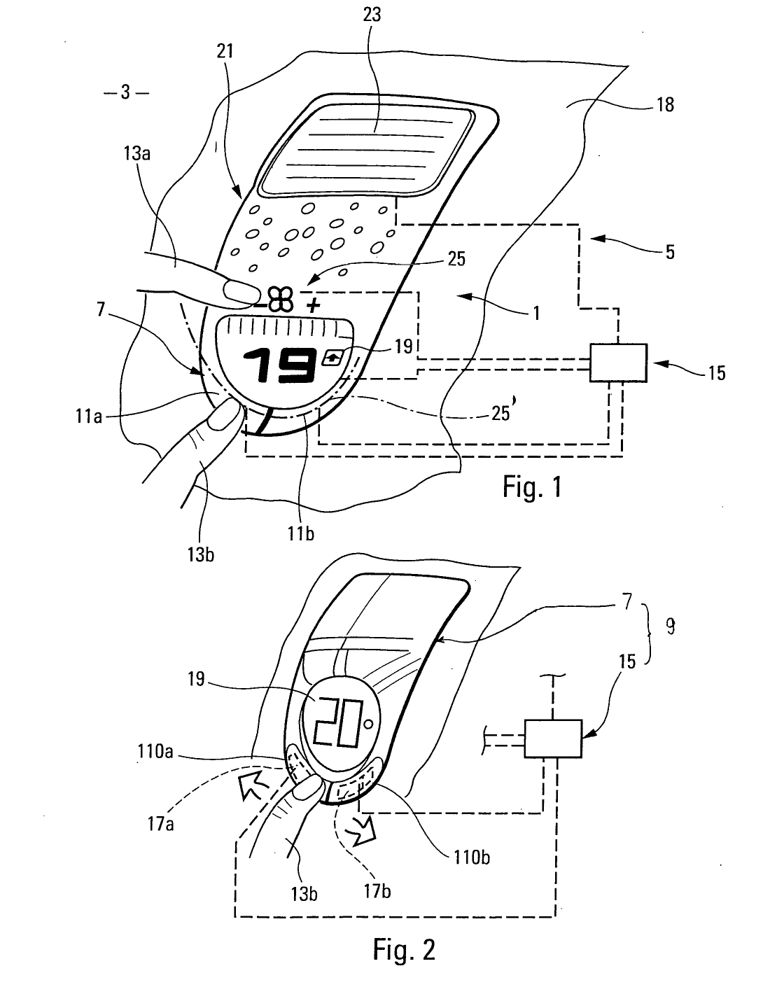

Other features and advantages of the invention will emerge from the complementary description which follows, given with reference to the accompanying drawings which are provided by way of non-limiting examples, as is the embodiment of this description, and in which FIGS. 1 and 2 are diagrams showing the touch-sensitive interface and its immediate surroundings.

FIG. 1 shows part of an instrument panel 1 of the cabin 3 of a motor vehicle 5.

This instrument panel 1—although it could be another zone in the cabin, such as an armrest or a door zone—here comprises a touch-sensitive interface 7 belonging to, or intended for, a heating and/or air-conditioning device 9 (FIG. 2) for the cabin of the vehicle.

The touch-sensitive interface 7 comprises at least one heat-sensitive wall, here two heat-sensitive walls 11a, 11b, accessible to the fingers 13a and/or 13b of the user and designed to be heated and/or cooled by heating and/or cooling means 15 arranged behind this wall so that upon contact with said wall, the user has a feeling of hot or cold.

In the preferred example considered, these means 15 perform heating and cooling.

These are cabin air-conditioning means coupled with command/control means.

For preference, the/each heat-sensitive wall 11a, 11b has, as illustrated more specifically in FIG. 2, two differentiated zones including a first zone 110a under which the heating means 17a are arranged and a second zone 110b under which the cooling means 17b are arranged.

These means 17a and 17b may be connected to the coupled heating and cooling means 15 and operate with them.

For that, respectively hot and cold ducts passing just underneath this/these wall(s) 11a, 11b are positioned just under the instrument panel trim lining 18, in order to alter the temperature thereof, or alternatively, a resistive element is used for hot and a coolant circulating in a closed circuit is used for cold, all this preferably being controlled by the heating and cooling means 15 operated by an on-board computer. Piezoelectric components and/or thermally conducting elements that collect the cold produced by the air-conditioning means themselves may also be arranged under the trim lining 18 to create the expected sensation.

Thus, the touch-sensitive interface 7 is preferably connected with such adjustable means 15 for air-conditioning the cabin by delivering into this cabin air at a more or less higher temperature or at a more or less cooler temperature. Control over the temperature of this delivered air is therefore dependent on the setting defined by the action of the fingers of the user over the interface.

For preference, for all-round comfort, a display 19 of the temperature delivered into the cabin by this system is provided. The display is coupled to the/each wall 11a, 11b and to the heating and/or cooling means 15 so as to display the temperature as a function of the movement of the finger across the heat-sensitive wall(s).

For preference, this/these heat-sensitive wall(s) belongs/belong to a flat or essentially flat touch-sensitive tile 21 with a surface area greater than that of a finger 13a or 13b and lying substantially flat, once mounted in the vehicle, as shown in the figures.

Access to this/these heat-sensitive wall(s) 11a, 11b becomes all the easier.

In FIGS. 1 and 2, dotted lines have been used to schematically represent (at least some of) the fluidic and/or electrical connections between the zones 110a, 110b and the heating and/or cooling means 15. One of these lines also shows, in FIG. 1, that air is blown into the cabin via said means 15 through, for example, the blower outlet 23 here provided on the instrument panel 1.

For that, the means 15 comprise, or are connected to, blowing means designed to blow and carry air, at a suitable temperature, to one and, a priori several, outlets arranged in the cabin.

The amount of blowing of the air generated by the temperature setting adopted can also be defined on the front panel, via the active adjusting zone 25 on which the finger 13a acts, again in conjunction with the means 15.

Regarding the procedure for acting on these adjustable cabin 3 heating or air-conditioning means 15, the procedure is preferably as follows:
at least the aforementioned heat-sensitive wall, and in this instance both walls 11a, 11b, accessible to the fingers of the user and therefore defining a touch-sensitive interface between this user and said heating and/or air-conditioning means 15 is/are heated and/or cooled,
and, as a function of the action of the finger(s) 13a, 13b of this user on said heat-sensitive wall(s), air that is more or less hot or more or less cold is delivered to the cabin by the means 15.

In FIG. 1 it will also be seen that the wall(s) 11a, 11b are embodied by a hot touch-sensitive zone and a cold touch-sensitive zone each elongate in a predominant direction, here preferably the same predominant direction 25′.

It will also be noted that these two respectively hot and cold touch-sensitive zones (corresponding respectively to the aforementioned zones 110a and 110b) here lie in the continuation of one another.

Thus, the user of the system will feel a hot or cold tactile sensation under at least one of his fingers, this indicating to him in particular in which direction—or which way—to move his finger over the interface, according to whether he wishes to increase or decrease the temperature in the cabin, and to act in this way, there is no need for him to make any visual check.

The desired cabin temperature can therefore be controlled in a “blind” way by the driver. By touching with his finger the driver (or some other user) will be able to perceive directly whether the finger has been placed on a hot or cold zone. Instinctively, when a user (for example the driver) wishes to lower the temperature he places his finger on the cold zone (11b) and vice versa, when he wishes to increase the temperature, he places his finger on the hot zone (11a). Depending on the time during which the finger is placed against one of the zones (or depending on the pressure applied, or on the direction in which the finger is moving, etc), the temperature setpoint is modified, in accordance with the driver's wishes. The driver does not therefore have his attention distracted by adjusting the temperature setting.

1. A touch-sensitive interface (7) for a heating and/or air-conditioning device (9) of a motor vehicle (5), this interface (7) being characterized in that it comprises at least one heat-sensitive wall (11a, 11b) accessible to the fingers (13a, 13b) of a user and designed to be heated and/or cooled by heating and/or cooling means (15, 17a, 17b) arranged behind this wall (11a, 11b) so that, upon contact with said wall, the user has a feeling of hot or cold.

2. The interface (7) as claimed in claim 1, characterized in that said wall (11a, 11b) has a cold touch-sensitive zone (110b) and a hot touch-sensitive zone (110a), each elongate in a predominant direction (25′).

3. The interface (7) as claimed in claim 2, characterized in that said two tactile zones (110a, 110b) are elongate in the same predominant direction (25′).

4. The interface (7) as claimed in claim 1, characterized in that said wall (11a, 11b) has two differentiated zones including a first zone (110a) under which the heating means (17a) are arranged and a second zone (110b) under which the cooling means (17b) are arranged.

5. The interface (7) as claimed in claim 1, characterized in that it comprises a temperature display (19) coupled to said wall (11a, 11b) and to the heating and/or cooling means (15, 17a, 17b) so as to display the temperature as a function of the movement of the finger (13a, 13b) across the heat-sensitive wall(s) (11a, 11b).

6. The interface (7) as claimed in claim 1, characterized in that the heat-sensitive wall(s) (11a, 11b) belongs (belong) to a flat or essentially flat touch-sensitive tile (21) with a surface area greater than that of a finger (13a, 13b) and lying substantially flat once mounted in the vehicle (5).

7. An air-conditioning device (9) for the air-conditioning of the cabin (3) of a motor vehicle, comprising:
the touch-sensitive interface (7) as claimed in claim 1, and
adjustable means (15) for the air-conditioning of the cabin (3) by delivering air at a more or less higher temperature or at a more or less cooler to this cabin, said air-conditioning means (15) being coupled to the touch-sensitive interface (1, 7) for controlling the temperature of the air delivered as a function of the setting defined by the action of the fingers (13a, 13b) of the user on the touch-sensitive interface (1, 7).

8. A motor vehicle (5) comprising a cabin (3) equipped with the interface (7) as claimed in claim 1.

9. A method for acting on adjustable means for heating or means for air-conditioning (15) the cabin (3) of a motor vehicle (5), characterized in that:
at least one heat-sensitive wall (11a, 11b) accessible to the fingers (13a, 13b) of a user and defining a touch-sensitive interface (7) between this user and said heating or air-conditioning means (15) is heated and/or cooled, and
air that is more or less hot or more or less cold is delivered into the cabin (3) via said heating or air-conditioning means (15) according to the action of the finger or fingers (13a, 13b) of the user on the heat-sensitive wall(s) (11a, 11b).

10. A motor vehicle (5) comprising a cabin (3) equipped with the air-conditioning device (9) as claimed in claim 7.
